(19) United States
(12) Patent Application Publication
(10) Pub. No.: US 2006/0258310 A1
(43) Pub. Date: Nov. 16, 2006

(54) Blank channel searching frequency modulation transmitter

(75) Inventor: Robert Tsao, Taipei City (TW)

Correspondence Address: Robert Tsao;9F, No. 37, Dongsing Road, Xinyi District, Taipei City, 110, TW

(73) Assignee: Good Way Technology Co., Ltd

(21) Appl. No.: 11/126,907

(22) Filed: May 12, 2005

(51) Int. Cl. H04B 1/18

(52) U.S. Cl. 455/161.1; 455/160.1

(57) ABSTRACT

The present invention discloses a blank channel searching frequency modulation transmitter, which includes a processor coupled respectively to a frequency modulation (FM) receiver, a comparator, a display, a controller, and a frequency modulation (FM) transmitter; wherein the FM transmitter is connected to a sound input device; the processor determines whether or not the searched channel is used by a radio; if yes, then search for the next channel; if no, then stop searching and use the searched channel to transmit a frequency modulation signal of the sound input device to a radio of the same channel. Therefore, users can listen to music from another sound input device through a blank radio channel without changing the existing radio structure, and the invention achieves the effect of a convenient uninterfered operation.

### FIELD OF THE INVENTION

The present invention relates to a blank channel frequency searching frequency modulation (FM) transmitter that allows users to listen to music from other sound input devices through a blank radio channel without changing the existing radio structure and provides users a convenient uninterfered operation.

### BACKGROUND OF THE INVENTION

The present electronic industry is developing in a fast pace, and particularly the audio/video products are changing day after day. The most popular one is the MP3 player, which features a small size, a large capacity, and an easiness to carry and store music data. Therefore, the MP3 player gradually takes over the market position of the conventional music player such as the portable CD player and radio. However, a MP3 player usually uses earphones or external speakers to listen to the played music, but it cannot use the existing high-end stereo for the playback. For example, if a user wants to listen to music in a car, the user has to use earphones, and thus the high-end stereo equipment of the car is apparently useless. Therefore, some manufacturers developed a frequency modulation (FM) transmitter that can be connected to the MP3 player, and the transmitting channel is modulated as the radio channel. By using a base station nearby, the music of a MP3 player can be loaded to the radio station, and thus the music of the MP3 player can be played back from the speakers of the stereo.

The foregoing FM transmitter seemingly solves the user's problem, but there still exists some hidden issues, such as the interference produced when the radio transmission power becomes stronger, and the users will be interfered continuously while appreciating the music. Such interference will be very significant, if the user listens to music in a car. Some users may be distracted by the interference and have to tune the channel, which adversely affects the driver's safety.

### SUMMARY OF THE INVENTION

In view of the shortcomings of the prior art FM transmitters, the inventor of the present invention based on years of experience in the related industry to conduct researches and overcome the aforementioned shortcomings, and finally invented a blank channel searching FM transmitter that allows users to listen to music from other sound input devices through a blank radio channel without changing the existing radio structure and provides users a convenient uninterfered operation.

Therefore, a primary objective of the present invention is to provide a blank channel searching FM transmitter that allows users to listen to music from other sound input devices through a blank radio channel without changing the existing radio structure and provides users a convenient uninterfered operation.

To achieve the foregoing objective, the blank channel searching FM transmitter in accordance with the present invention comprises a processor coupled respectively to a frequency modulation (FM) receiver, a comparator, a display, a controller, and a frequency modulation transmitter; wherein the FM transmitter is connected to a sound input device; the processor can determine whether or not the searched channel is used by a radio; if yes, then search for the next channel; if no, then stop searching and use the channel to transmit a frequency modulation signal of the sound input device to a radio of the same channel. Therefore, users can listen to music from another sound input device through a blank radio channel without changing the existing radio structure, and the invention achieves the effect of a convenient uninterfered operation.

### BRIEF DESCRIPTION OF THE DRAWINGS

FIG. 1 is a block diagram of the structure of present invention;

FIG. 2 is a flow chart of searching a channel of the present invention; and

FIG. 3 shows an application according to a preferred embodiment of the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

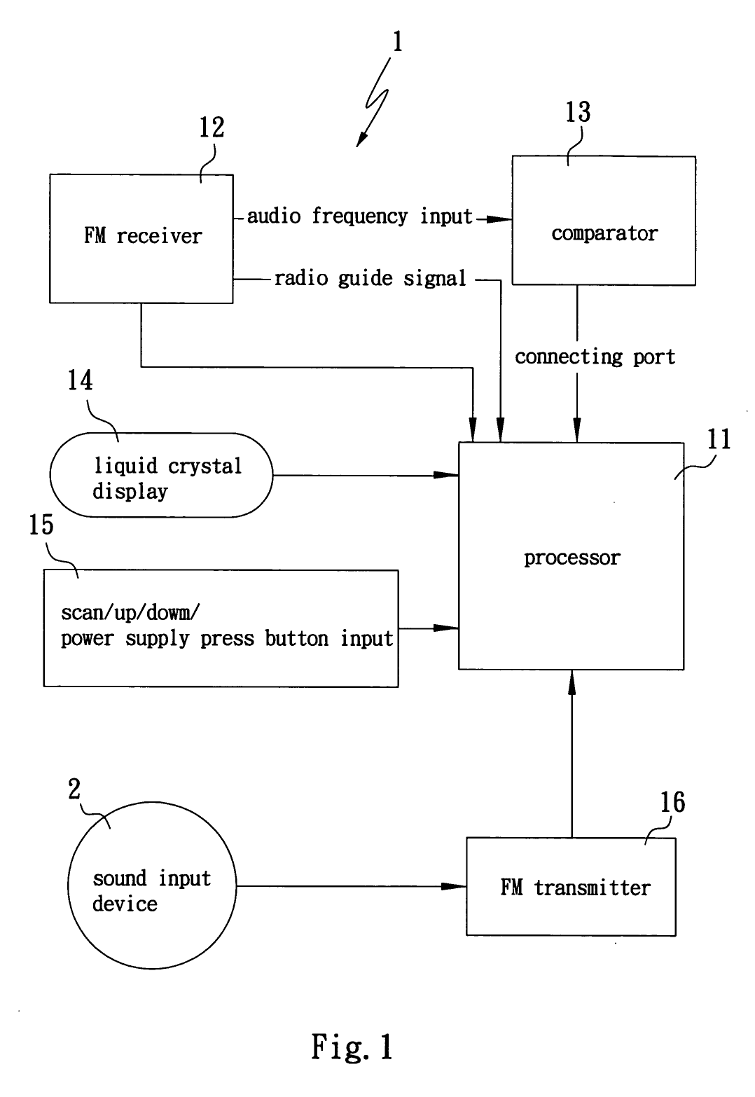

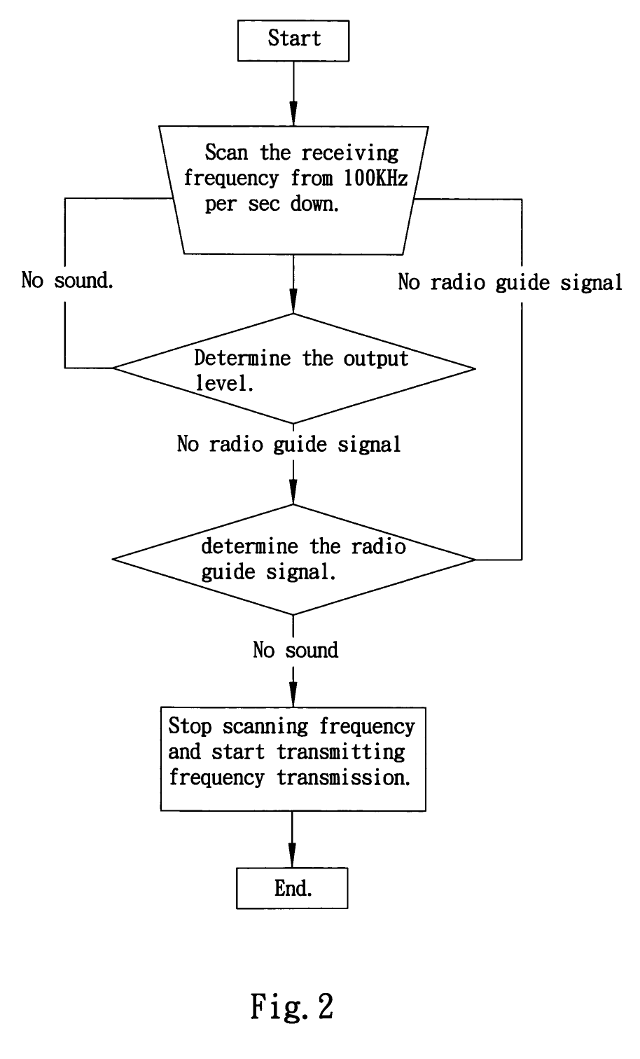

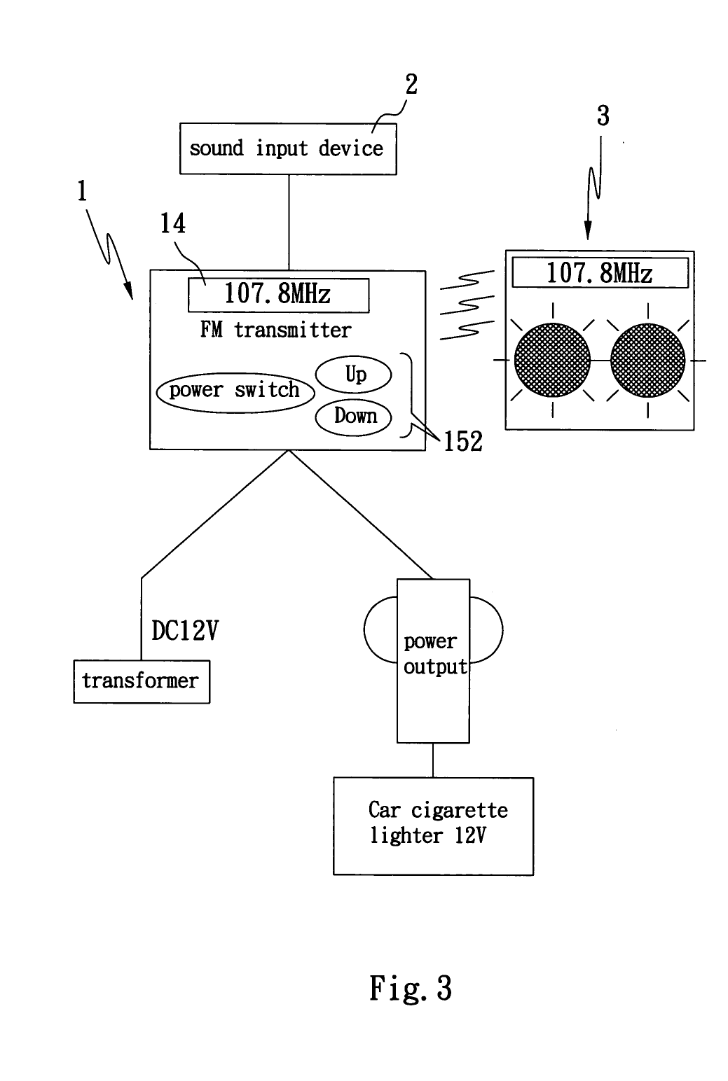

Referring to FIGS. 1 to 3 for the structural block diagram, the search flow chart and the preferred embodiment of the present invention respectively, the blank channel searching frequency modulation (FM) transmitter 1 includes a processor 11, and the processor 11 is coupled respectively to a frequency modulation receiver 12, a comparator 13, a display 14, a controller 15 and a frequency modulation transmitter 16; wherein the controller 15 includes a power switch 151 and an up/down search button 152, and the controller 15 constantly resets a channel and allows the processor 11 to synchronously modulate the channels of the frequency modulation receiver 12 and the frequency modulation transmitter 16; the display 14 could be a liquid crystal display that displays the current channel number modulated by the processor 11; the comparator 13 receives an audio frequency signal of the modulation frequency receiver 12 and converts the audio frequency signal into a digital signal and sends the digital signal to the processor 11; the frequency modulation receiver 12 sends the audio frequency signal of a set channel to the comparator 13 and a radio guide signal of the set channel to the processor 11; the frequency modulation transmitter 16 is coupled to the sound input device 2 (which could be a MP3 player) and loads the audio frequency of the audio input device 2 to the frequency modulation to be transmitted; and the processor 11 scans the receiving frequency by 100 KHz per second and determines whether or not the searched channel has a sound or a radio guide signal; if yes, then search for the next channel; if no, then stop searching and use the channel to transmit a frequency modulation signal of the sound input device 2 to a radio 3 of the same channel.

The structural design of the present invention also can be used by using the power supply of a cigarette lighter of a car or connecting to the city power through a transformer. After the power is turned on, the blank channels are scanned automatically up or down at 100 KHz per second; and after it is confirmed that the searched channel is not used by any radio station, then it will stop searching and use the blank channel to transmit an audio frequency of the sound input device 2, so as to modulate the channel to the same channel of the radio 3 for a music playback. Therefore, the music from the sound input device 2 can be listened through the blank channel of the radio 2 without changing the existing structure of the radio 2, and the present invention achieves the effect of a convenient and uninterfered operation.

In summation of the above description, the design of the USB camera in accordance with the present invention enhances the performance over the conventional structure and further complies with the patent application requirements and is submitted to the Patent and Trademark Office for review and granting of the commensurate patent rights.

What is claimed is:

1. A blank channel searching frequency modulation transmitter, comprising a processor, and said processor being coupled respectively to a frequency modulation receiver, a comparator, a display, a controller and a frequency modulation transmitter; wherein:
said controller constantly resets a channel and allows said processor to synchronously modulate the channels of said frequency modulation receiver and said frequency modulation transmitter;
said display displays the current channel number modulated by said processor;
said comparator receives an audio frequency signal of said modulation frequency receiver and converts said audio frequency signal into a digital signal and sends said digital signal to said processor;
said frequency modulation receiver sends said audio frequency signal of a set channel to said comparator and a radio guide signal of said set channel to said processor;
said frequency modulation transmitter is coupled to said sound input device and loads said audio frequency of said audio input device to said frequency modulation to be transmitted; and
said processor determines whether or not said searched channel is used by a radio; if yes, then search for the next channel; if no, then stop searching and use said channel to transmit a frequency modulation signal of said sound input device to a radio of the same channel.

2. The blank channel searching frequency modulation transmitter of claim 1, wherein said sound input device is a MP3 player.

3. The blank channel searching frequency modulation transmitter of claim 1, wherein said controller has a power switch and an up/down search button.

4. The blank channel searching frequency modulation transmitter of claim 1, wherein said display is a liquid crystal display.
